(19) United States
(12) Patent Application Publication
(10) Pub. No.: US 2026/0277765 A1
(43) Pub. Date: Sep. 17, 2026

(54) Optimizing Computing Resource Allocation for Different Artificial Intelligence Workloads

(71) Applicant: International Business Machines Corporation, Armonk, NY (US)

(72) Inventors: Dong Hui Liu, Beijing (CN); Peng Hui Jiang, Beijing (CN); Jia Tian Zhong, Hong Kong (HK); Jing Lu, Beijing (CN); Jia Yu, Beijing (CN)

(21) Appl. No.: 19/078,683

(22) Filed: Mar. 13, 2025

(51) Int. Cl. G06F 11/34; G06F 9/50

(52) U.S. Cl. CPC G06F 11/3433; G06F 9/505; G06F 11/3452

(57) ABSTRACT

Computing resource management is provided. Time series predictions of future allocation of number and type of computing resources needed on a compute node to run an AI workload are generated based on real-time performance data corresponding to the AI workload running on the compute node. It is determined whether runtime computing resource reallocation is needed on the compute node based on the time series predictions. In response to determining that the runtime computing resource reallocation is needed on the compute node based on the time series predictions, the runtime computing resource reallocation is performed on the compute node automatically to adjust at least one of the number and the type of the computing resources needed on the compute node to run the AI workload.

### BACKGROUND

The disclosure relates generally to computing resources and more specifically to computing resource allocation.

Application workloads need computing resources to run. Computing resources can include, for example, processors, memory, storage, network devices, and the like. Heterogeneous computing environments, such as cloud computing environments, offer a vast number of different types of computing resources to meet the needs of different types of application workloads at various levels. Computing resource allocation is the process of selecting and scheduling appropriate computing resources to complete a particular application workload. A goal of computing resource allocation is to utilize computing resources as efficiently as possible to avoid delays and minimize costs.

### SUMMARY

According to one illustrative embodiment, a computer-implemented method is provided. The computer-implemented method generates time series predictions of future allocation of number and type of computing resources needed on a compute node to run an Artificial Intelligence (AI) workload based on real-time performance data corresponding to the AI workload running on the compute node. The computer-implemented method determines whether runtime computing resource reallocation is needed on the compute node based on the time series predictions of the future allocation of the number and the type of the computing resources needed on the compute node to run the AI workload. In response to determining that the runtime computing resource reallocation is needed on the compute node based on the time series predictions of the future allocation of the number and the type of the computing resources needed on the compute node to run the AI workload, the computer-implemented method performs the runtime computing resource reallocation on the compute node automatically to adjust at least one of the number and the type of the computing resources needed on the compute node to run the AI workload. According to other illustrative embodiments, a computer system and computer program product are provided.

### BRIEF DESCRIPTION OF THE DRAWINGS

FIG. 1 is a pictorial representation of a computing environment in which illustrative embodiments may be implemented;

FIG. 2 is a diagram illustrating an example of a computing resource management system in accordance with an illustrative embodiment; and

FIGS. 3A-3B are a flowchart illustrating a process for optimizing computing resource allocation for different Artificial Intelligence (AI) workloads in accordance with an illustrative embodiment.

### DETAILED DESCRIPTION

A computer-implemented method generates time series predictions of future allocation of number and type of computing resources needed on a compute node to run an Artificial Intelligence (AI) workload based on real-time performance data corresponding to the AI workload running on the compute node. The computer-implemented method determines whether runtime computing resource reallocation is needed on the compute node based on the time series predictions of the future allocation of the number and the type of the computing resources needed on the compute node to run the AI workload. In response to determining that the runtime computing resource reallocation is needed on the compute node based on the time series predictions of the future allocation of the number and the type of the computing resources needed on the compute node to run the AI workload, the computer-implemented method performs the runtime computing resource reallocation on the compute node automatically to adjust at least one of the number and the type of the computing resources needed on the compute node to run the AI workload. As a result, illustrative embodiments provide a technical effect of automatically adjusting computing resources on a compute node running an AI workload based on time series predictions of future allocation of the computing resources needed on the compute node to run the AI workload to continuously optimize the computing resource allocation to match the evolving needs of the running AI workload.

Also, the computer-implemented method determines whether the AI workload has completed running on the compute node. In response to determining that the AI workload has completed running on the compute node, the computer-implemented method collects completed workload performance data corresponding to the AI workload. The computer-implemented method utilizes the completed workload performance data corresponding to the AI workload as feedback to a regression machine learning model to increase predictive accuracy of the regression machine learning model. As a result, illustrative embodiments provide a technical effect of increasing predictive accuracy of a regression machine learning model that generates time series predictions of future computing resource allocation needed on a compute node to run an AI workload by utilizing completed workload performance data corresponding to the AI workload as feedback to the regression machine learning model to increase accuracy and efficiency of AI workload resource allocation management of illustrative embodiments.

In addition, the computer-implemented method performs static code analysis of the AI workload in response to receiving the AI workload. The static code analysis includes at least one of source code analysis, runtime libraries analysis, system calls analysis, and instructions for binary analysis. As a result, illustrative embodiments provide a technical effect of performing static code analysis, which includes at least one of source code analysis, runtime libraries analysis, system calls analysis, and instructions for binary analysis, of an AI workload.

Further, the computer-implemented method identifies a type of the AI workload based on static code analysis of the AI workload. The type of the AI workload is one of a data processing AI workload type, a machine learning AI workload type, a deep learning AI workload type, a training AI workload type, an inference AI workload type, and a data analysis AI workload type. As a result, illustrative embodiments provide a technical effect of identifying a type of an AI workload, which is one of a data processing AI workload type, a machine learning AI workload type, a deep learning AI workload type, a training AI workload type, an inference AI workload type, and a data analysis AI workload type, based on static code analysis of the AI workload.

Furthermore, the computer-implemented method retrieves historical performance data corresponding to a type of the AI workload. The computer-implemented method predicts the number and the type of the computing resources needed to run the AI workload based on the historical performance data corresponding to the type of the AI workload using a regression machine learning model trained on the historical performance data corresponding to the type of the AI workload. As a result, illustrative embodiments provide a technical effect of predicting number and type of computing resources needed to run an AI workload based on historical performance data corresponding to a type of the AI workload using a regression machine learning model trained on the historical performance data corresponding to the type of the AI workload.

Moreover, the computer-implemented method selects the compute node having the number and the type of the computing resources needed to run the AI workload. The compute node is one of a plurality of compute nodes having different computing resources within a heterogeneous computing environment. The computer-implemented method runs the AI workload on the compute node having the number and the type of the computing resources needed to run the AI workload. As a result, illustrative embodiments provide a technical effect of running an AI workload on a compute node having the appropriate number and type of computing resources needed to run the AI workload.

The computer-implemented method also collects the real-time performance data corresponding to the AI workload running on the compute node having the number and the type of the computing resources needed to run the AI workload. As a result, illustrative embodiments provide a technical effect of collecting real-time performance data corresponding to an AI workload running on a compute node having the appropriate number and the type of the computing resources needed to run the AI workload in order to generate time series predictions of future allocation of the number and type of computing resources needed on the compute node to run the AI workload.

A computer system comprises a processor set, one or more computer-readable storage media, and program instructions stored on the one or more computer-readable storage media to cause the processor set to perform operations. The computer system generates time series predictions of future allocation of number and type of computing resources needed on a compute node to run an Artificial Intelligence (AI) workload based on real-time performance data corresponding to the AI workload running on the compute node. The computer system determines whether runtime computing resource reallocation is needed on the compute node based on the time series predictions of the future allocation of the number and the type of the computing resources needed on the compute node to run the AI workload. In response to determining that the runtime computing resource reallocation is needed on the compute node based on the time series predictions of the future allocation of the number and the type of the computing resources needed on the compute node to run the AI workload, the computer system performs the runtime computing resource reallocation on the compute node automatically to adjust at least one of the number and the type of the computing resources needed on the compute node to run the AI workload. As a result, illustrative embodiments provide a technical effect of automatically adjusting computing resources on a compute node running an AI workload based on time series predictions of future allocation of the computing resources needed on the compute node to run the AI workload to continuously optimize the computing resource allocation to match the evolving needs of the running AI workload.

Also, the computer system determines whether the AI workload has completed running on the compute node. In response to determining that the AI workload has completed running on the compute node, the computer system collects completed workload performance data corresponding to the AI workload. The computer system utilizes the completed workload performance data corresponding to the AI workload as feedback to a regression machine learning model to increase predictive accuracy of the regression machine learning model. As a result, illustrative embodiments provide a technical effect of increasing predictive accuracy of a regression machine learning model that generates time series predictions of future computing resource allocation needed on a compute node to run an AI workload by utilizing completed workload performance data corresponding to the AI workload as feedback to the regression machine learning model to increase accuracy and efficiency of AI workload resource allocation management of illustrative embodiments.

In addition, the computer system performs static code analysis of the AI workload in response to receiving the AI workload. The static code analysis includes at least one of source code analysis, runtime libraries analysis, system calls analysis, and instructions for binary analysis. As a result, illustrative embodiments provide a technical effect of performing static code analysis, which includes at least one of source code analysis, runtime libraries analysis, system calls analysis, and instructions for binary analysis, of an AI workload.

Further, the computer system identifies a type of the AI workload based on static code analysis of the AI workload. The type of the AI workload is one of a data processing AI workload type, a machine learning AI workload type, a deep learning AI workload type, a training AI workload type, an inference AI workload type, and a data analysis AI workload type. As a result, illustrative embodiments provide a technical effect of identifying a type of an AI workload, which is one of a data processing AI workload type, a machine learning AI workload type, a deep learning AI workload type, a training AI workload type, an inference AI workload type, and a data analysis AI workload type, based on static code analysis of the AI workload.

Furthermore, the computer system retrieves historical performance data corresponding to a type of the AI workload. The computer system predicts the number and the type of the computing resources needed to run the AI workload based on the historical performance data corresponding to the type of the AI workload using a regression machine learning model trained on the historical performance data corresponding to the type of the AI workload. As a result, illustrative embodiments provide a technical effect of predicting number and type of computing resources needed to run an AI workload based on historical performance data corresponding to a type of the AI workload using a regression machine learning model trained on the historical performance data corresponding to the type of the AI workload.

Moreover, the computer system selects the compute node having the number and the type of the computing resources needed to run the AI workload. The compute node is one of a plurality of compute nodes having different computing resources within a heterogeneous computing environment. The computer system runs the AI workload on the compute node having the number and the type of the computing resources needed to run the AI workload. As a result, illustrative embodiments provide a technical effect of running an AI workload on a compute node having the appropriate number and type of computing resources needed to run the AI workload.

A computer program product comprises one or more computer-readable storage media and program instructions stored on the one or more computer-readable storage media to perform operations. The computer program product generates time series predictions of future allocation of number and type of computing resources needed on a compute node to run an Artificial Intelligence (AI) workload based on real-time performance data corresponding to the AI workload running on the compute node. The computer program product determines whether runtime computing resource reallocation is needed on the compute node based on the time series predictions of the future allocation of the number and the type of the computing resources needed on the compute node to run the AI workload. In response to determining that the runtime computing resource reallocation is needed on the compute node based on the time series predictions of the future allocation of the number and the type of the computing resources needed on the compute node to run the AI workload, the computer program product performs the runtime computing resource reallocation on the compute node automatically to adjust at least one of the number and the type of the computing resources needed on the compute node to run the AI workload. As a result, illustrative embodiments provide a technical effect of automatically adjusting computing resources on a compute node running an AI workload based on time series predictions of future allocation of the computing resources needed on the compute node to run the AI workload to continuously optimize the computing resource allocation to match the evolving needs of the running AI workload.

Also, the computer program product determines whether the AI workload has completed running on the compute node. In response to determining that the AI workload has completed running on the compute node, the computer program product collects completed workload performance data corresponding to the AI workload. The computer program product utilizes the completed workload performance data corresponding to the AI workload as feedback to a regression machine learning model to increase predictive accuracy of the regression machine learning model. As a result, illustrative embodiments provide a technical effect of increasing predictive accuracy of a regression machine learning model that generates time series predictions of future computing resource allocation needed on a compute node to run an AI workload by utilizing completed workload performance data corresponding to the AI workload as feedback to the regression machine learning model to increase accuracy and efficiency of AI workload resource allocation management of illustrative embodiments.

In addition, the computer program product performs static code analysis of the AI workload in response to receiving the AI workload. The static code analysis includes at least one of source code analysis, runtime libraries analysis, system calls analysis, and instructions for binary analysis. As a result, illustrative embodiments provide a technical effect of performing static code analysis, which includes at least one of source code analysis, runtime libraries analysis, system calls analysis, and instructions for binary analysis, of an AI workload.

Further, the computer program product identifies a type of the AI workload based on static code analysis of the AI workload. The type of the AI workload is one of a data processing AI workload type, a machine learning AI workload type, a deep learning AI workload type, a training AI workload type, an inference AI workload type, and a data analysis AI workload type. As a result, illustrative embodiments provide a technical effect of identifying a type of an AI workload, which is one of a data processing AI workload type, a machine learning AI workload type, a deep learning AI workload type, a training AI workload type, an inference AI workload type, and a data analysis AI workload type, based on static code analysis of the AI workload.

Furthermore, the computer program product retrieves historical performance data corresponding to a type of the AI workload. The computer program product predicts the number and the type of the computing resources needed to run the AI workload based on the historical performance data corresponding to the type of the AI workload using a regression machine learning model trained on the historical performance data corresponding to the type of the AI workload. As a result, illustrative embodiments provide a technical effect of predicting number and type of computing resources needed to run an AI workload based on historical performance data corresponding to a type of the AI workload using a regression machine learning model trained on the historical performance data corresponding to the type of the AI workload.

Moreover, the computer program product selects the compute node having the number and the type of the computing resources needed to run the AI workload. The compute node is one of a plurality of compute nodes having different computing resources within a heterogeneous computing environment. The computer program product runs the AI workload on the compute node having the number and the type of the computing resources needed to run the AI workload. As a result, illustrative embodiments provide a technical effect of running an AI workload on a compute node having the appropriate number and type of computing resources needed to run the AI workload.

The computer program product also collects the real-time performance data corresponding to the AI workload running on the compute node having the number and the type of the computing resources needed to run the AI workload. As a result, illustrative embodiments provide a technical effect of collecting real-time performance data corresponding to an AI workload running on a compute node having the appropriate number and the type of the computing resources needed to run the AI workload in order to generate time series predictions of future allocation of the number and type of computing resources needed on the compute node to run the AI workload.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A CPP embodiment is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

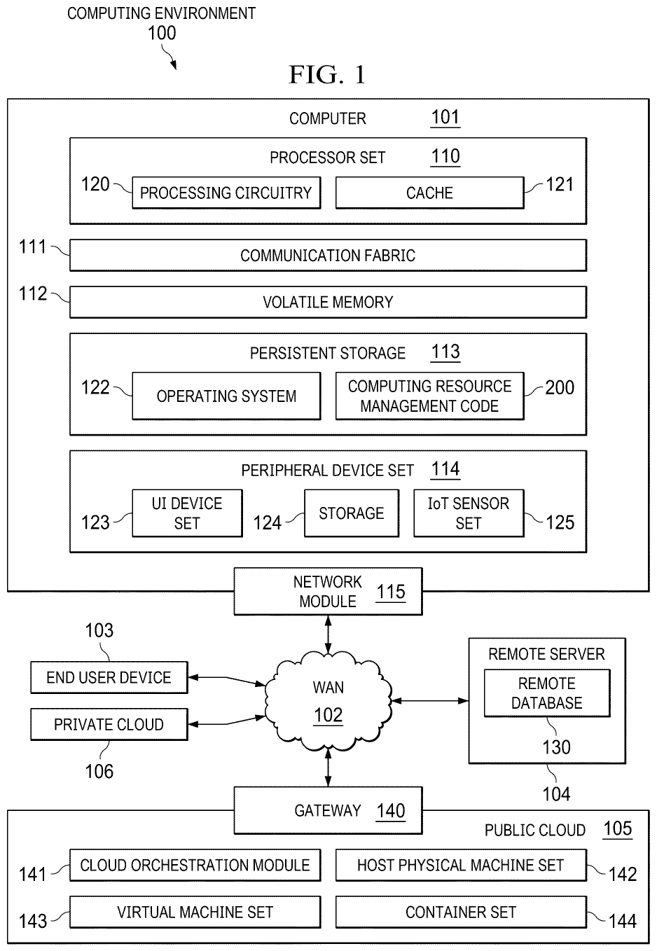

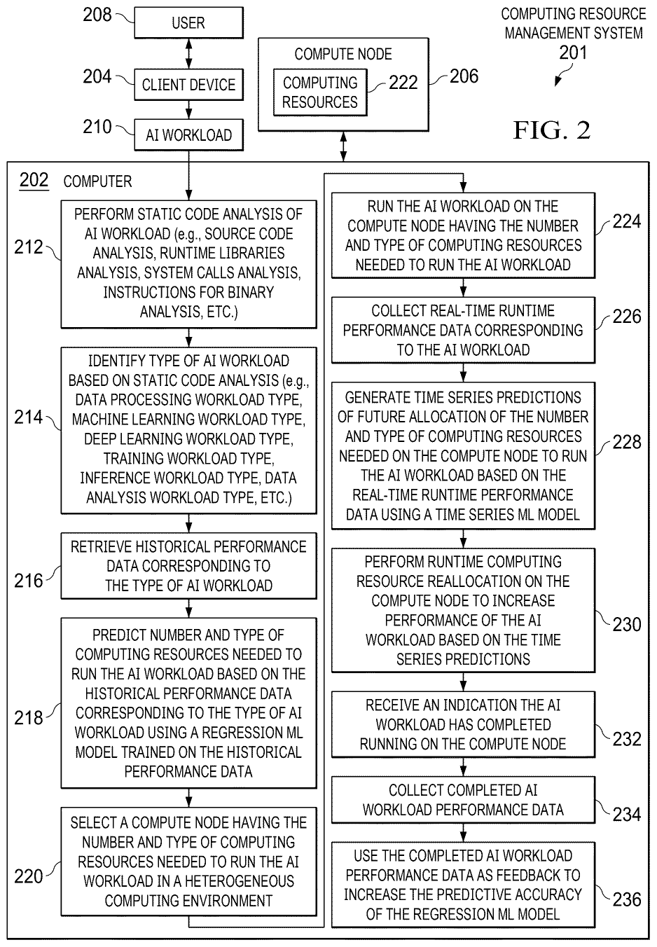

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of a heterogeneous computing environment for the execution of at least some of the computer code involved in performing the inventive methods of illustrative embodiments, such as computing resource management code 200.

For example, computing resource management code 200 initially predicts the number and type of computing resources needed for a particular Artificial Intelligence (AI) workload by analyzing historical performance data corresponding to that particular AI workload's type. This initial prediction enables computing resource management code 200 to accurately and efficiently allocate computing resources at the start of an AI workload.

In addition, computing resource management code 200 dynamically adjusts and refines the computing resource allocation for an AI workload during runtime based on collected real-time performance data corresponding to that particular AI workload. For example, by utilizing time series predictions based on the real-time performance data, computing resource management code 200 can continuously optimize the computing resource allocation to match the evolving needs of the running AI workload.

Further, computing resource management code 200 utilizes a feedback loop that collects performance data after each AI workload completes running. Illustrative embodiments use this feedback loop to increase the accuracy of future computing resource allocation predictions, allowing for continuous refinement of resource allocation predictions and resource allocation adjustments by updating the historic performance data with new historic performance data as AI workloads complete running. This feedback enables computing resource management code 200 to continually learn and evolve with each AI workload, resulting in more accurate and efficient resource allocation management over time.

In addition to computing resource management code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and computing resource management code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a server, mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in computing resource management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source portable operating system interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices.

Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers.

IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a system administrator or the like who utilizes the computing resource management services provided by computer 101), and may take any of the forms discussed above in connection with computer 101. EUD 103 typically receives helpful and useful data from the operations of computer 101. For example, in a hypothetical case where computer 101 is designed to provide a computing resource allocation recommendation to the end user, this recommendation would typically be communicated from network module 115 of computer 101 through WAN 102 to EUD 103. In this way, EUD 103 can display, or otherwise present, the computing resource allocation recommendation to the end user. In some embodiments, EUD 103 may be a client device, such as a thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a computing resource allocation prediction based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A, one of item B, and ten of item C, or four of item B and seven of item C, or other suitable combinations.

The rapid development of AI has led to a variety of AI workloads with diverse computational needs. For example, different AI workloads, such as machine learning model training workloads, inference workloads, data processing workloads, or the like, often need distinct hardware computing resources to perform efficiently and effectively. For instance, training deep neural networks typically benefits from Graphics Processing Units (GPUs) or Tensor Processing Units (TPUs), which are optimized for parallel processing and handling large-scale matrix operations, while simpler tasks such as data processing or less compute-intensive models may run more effectively on traditional Central Processing Units (CPUs). Additionally, hardware accelerators such as Field Programmable Gate Arrays (FPGAs) are increasingly used in AI applications for specialized workloads due to the ability of FPGAs to be customized for specific AI workloads.

However, the multitude of available hardware computing resources, ranging from CPUs to GPUs, TPUs, and FPGAs, presents a challenge for users such as AI practitioners and data scientists. For example, many of these users may not be familiar with the intricacies of heterogeneous computing environments or systems and the optimal use of different computing hardware types. As a result, efficiently utilizing the appropriate computing resources for specific AI workloads is not straightforward. Often, AI practitioners face the challenge of manually determining the best-suited computing hardware to utilize for each AI workload, leading to suboptimal computing resource utilization and performance bottlenecks.

The challenge of manually determining the best-suited computing hardware for each AI workload is further amplified by the need to balance resource allocation across multiple types of computing hardware, while considering factors such as computational intensity, memory usage, bandwidth requirements, and cost efficiency. Hence, there is a need for an automated method to intelligently analyze AI workloads and allocate the appropriate computing resources in heterogeneous computing environments such as cloud environments. Optimizing computing resource allocation in such heterogeneous computing environments is needed to improve performance, minimize costs, and efficiently utilize the capabilities of AI infrastructures.

Illustrative embodiments utilize static code analysis of an AI workload to determine the AI workload type and automatically identify the compute node having the appropriate computing hardware resources to run the AI workload. The compute node can be, for example, at least one of CPU intensive, GPU intensive, TPU intensive, memory intensive, IO intensive, or the like.

Illustrative embodiments utilize historical performance data of the AI workload to automatically identify the computing resources needed for that AI workload. The AI workload historical performance data include, for example, response times, memory usage, GPU memory usage, CPU time, maximum thread number, lock queue, lock wait times, heap size, filesystem utilization, IO rates, database connections, and the like.

Illustrative embodiments build a machine learning model to predict the compute node capabilities (i.e., hardware computing resources) needed for a specific AI workload type. For example, illustrative embodiments use the machine learning model to predict the number and type of processing units and amount of memory to allocate based on the identified AI workload type.

Illustrative embodiments automatically adjust and refine the hardware computing resource allocation during AI workload runtime based on collected real-time performance data corresponding to the AI workload. By utilizing time series predictions based on collected real-time performance data, illustrative embodiments can continuously optimize the computing resource allocation to match the evolving needs of the AI workload.

The automatic runtime tuning capabilities of illustrative embodiment include, for example, adjusting the number CPUs needed, number of GPUs, TPUs, or FPGAs needed if appropriate, maximum memory size needed, disk size needed, filesystem needed, database connections needed, and the like.

Furthermore, illustrative embodiments collect performance data after each AI workload completes running. Illustrative embodiments utilize this completed AI workload performance data as feedback to improve accuracy of future computing resource allocation predictions for AI workloads, allowing for continuous refinement of these computing resource allocation predictions and adjustments by updating the previous historical performance data with this new completed AI workload performance data.

As a result, illustrative embodiments provide automatic provisioning and managing of AI workloads in heterogeneous computing environments. In other words, by auto-detecting the AI model type and AI workload type, illustrative embodiments can provision a computing node (e.g., host node, worker node, or the like) to optimize the utilization of hardware computing resources in a heterogeneous computing environment, while enabling the current hardware to handle a greater AI workload.

Thus, illustrative embodiments provide one or more technical solutions that overcome a technical problem with how to determine the optimum computing resource allocation for different AI workloads. As a result, these one or more technical solutions provide a technical effect and practical application in the field of AI workload performance.

With reference now to FIG. 2, a diagram illustrating an example of a computing resource management system is depicted in accordance with an illustrative embodiment. Computing resource management system 201 may be implemented in a computing environment, such as computing environment 100 in FIG. 1. Computing resource management system 201 is a collection of hardware and software components for optimizing allocation of computing resources for different AI workloads by analyzing historical and real-time performance data corresponding to different AI workloads running in a heterogeneous computing environment.

In this example, computing resource management system 201 includes computer 202, client device 204, and compute node 206. Computer 202 may be, for example, computer 101 in FIG. 1. Client device 204 may be, for example, EUD 103 in FIG. 1. Compute node 206 may be, for example, one of host physical machine set 142 in FIG. 1. However, it should be noted that computing resource management system 201 is intended as an example only and not as a limitation on illustrative embodiments. For example, computing resource management system 201 may include any number of computers, client devices, compute nodes, and other devices and components not shown.

In this example, user 208, using client device 204, inputs AI workload 210 into computer 202 for computing resource utilization analysis and optimization. At 212, in response to receiving AI workload 210, computer 202 performs static code analysis of AI workload 210. The static code analysis can include, for example, at least one of source code analysis, runtime libraries analysis, system calls analysis, instructions for binary analysis, and the like.

At 214, computer 202 identifies the type of AI workload 210 based on the static code analysis. The type of AI workload 210 may be, for example, a data processing workload type, a machine learning workload type, a deep learning workload type, a training workload type, an inference workload type, a data analysis workload type, or the like. At 216, computer 202 retrieves historical performance data corresponding to the type of AI workload 210.

At 218, computer 202 predicts the number and type of computing resources needed to run AI workload 210 based on the historical performance data corresponding to the type of AI workload 210 using a regression machine learning model trained on the historical performance data corresponding to the type of AI workload 210. At 220, computer 202 selects a compute node (e.g., compute node 206) having the number and type of computing resources needed to run AI workload 210 (e.g., computing resources 222). It should be noted that compute node 206 is one of a plurality of compute nodes having different numbers and types of computing resources. Computing resources 222 may include, for example, one or more of CPUs, GPUs, TPUs, and/or FPGAs. Computing resources 222 may also include, for example, memory, storage, network devices, and the like. The plurality of compute nodes are operating in a heterogeneous computing environment, such as, for example, public cloud 105 or private cloud 106 in FIG. 1.

At 224, computer 202 runs AI workload 210 on compute node 206 having the number and type of computing resources 222 needed to run AI workload 210. In addition, at 226, computer 202 collects real-time runtime performance data corresponding to AI workload 210.

Further, at 228, computer 202 generates time series predictions of future allocation of the number and type of computing resources 222 needed on compute node 206 to run AI workload 210 based on the real-time runtime performance data corresponding to AI workload 210 using a time series machine learning model. At 230, computer 202 performs runtime computing resource reallocation on compute node 206 to increase performance of AI workload 210 based on the time series predictions.

At 232, computer 202 receives an indication that AI workload 210 has completed running on compute node 206. At 234, in response to receiving the indication that AI workload 210 has completed running on compute node 206, computer 202 collects completed AI workload performance data. At 236, computer 202 uses the completed AI workload performance data as feedback to increase the predictive accuracy of the regression machine learning model.

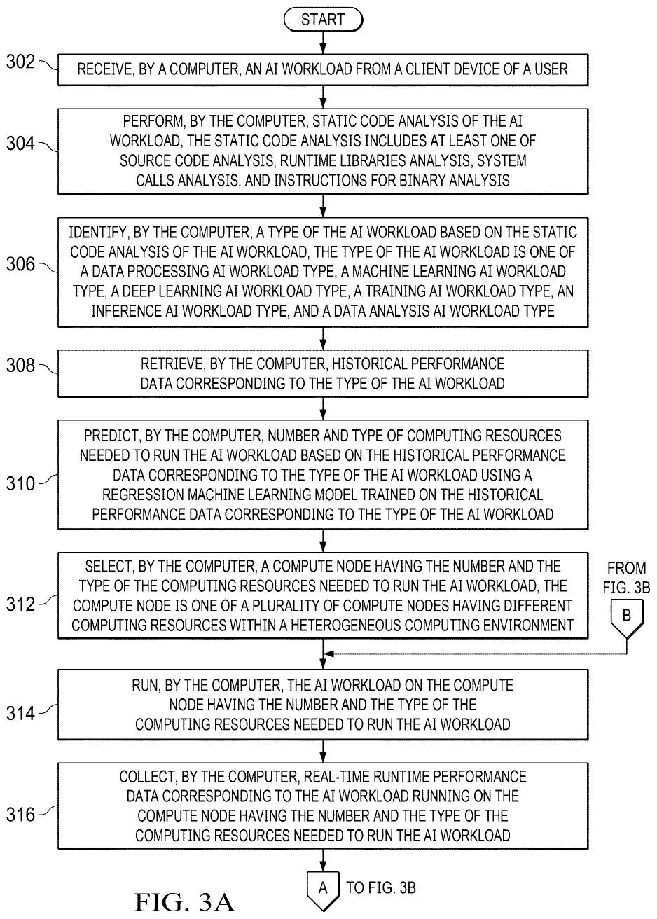

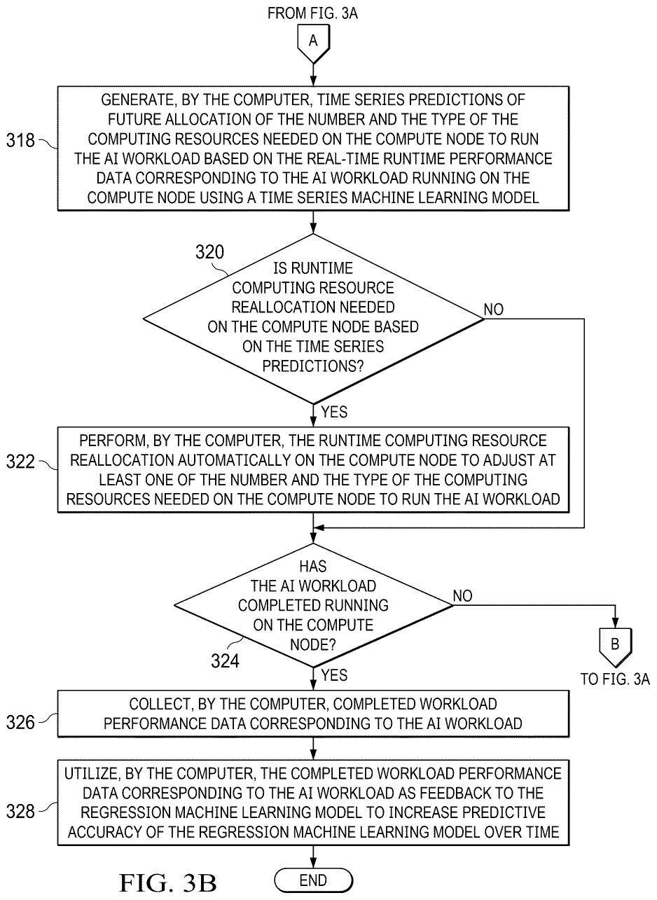

With reference now to FIGS. 3A-3B, a flowchart illustrating a process for optimizing computing resource allocation for different AI workloads is shown in accordance with an illustrative embodiment. The process shown in FIGS. 3A-3B may be implemented in a computer, such as, for example, computer 101 in FIG. 1 or computer 202 in FIG. 2. For example, the process shown in FIGS. 3A-3B may be implemented by computing resource management code 200 in FIG. 1.

The process begins when the computer receives an AI workload from a client device of a user (step 302). In response to receiving the AI workload, the computer performs static code analysis of the AI workload (step 304). The static code analysis includes at least one of source code analysis, runtime libraries analysis, system calls analysis, and instructions for binary analysis.

The computer identifies a type of the AI workload based on the static code analysis of the AI workload (step 306). The type of the AI workload is one of a data processing AI workload type, a machine learning AI workload type, a deep learning AI workload type, a training AI workload type, an inference AI workload type, and a data analysis AI workload type. Afterward, the computer retrieves historical performance data corresponding to the type of the AI workload (step 308).

The computer predicts number and type of computing resources needed to run the AI workload based on the historical performance data corresponding to the type of the AI workload using a regression machine learning model trained on the historical performance data corresponding to the type of the AI workload (step 310). The computer selects a compute node having the number and the type of the computing resources needed to run the AI workload (step 312). The compute node is one of a plurality of compute nodes having different computing resources within a heterogeneous computing environment.

Subsequently, the computer runs the AI workload on the compute node having the number and the type of the computing resources needed to run the AI workload (step 314). In addition, the computer collects real-time runtime performance data corresponding to the AI workload running on the compute node having the number and the type of the computing resources needed to run the AI workload (step 316).

The computer generates time series predictions of future allocation of the number and the type of the computing resources needed on the compute node to run the AI workload based on the real-time runtime performance data corresponding to the AI workload running on the compute node using a time series machine learning model (step 318). The computer makes a determination as to whether runtime computing resource reallocation is needed on the compute node based on the time series predictions of the future allocation of the number and the type of the computing resources needed on the compute node to run the AI workload (step 320).

If the computer determines that the runtime computing resource reallocation is not needed on the compute node based on the time series predictions of the future allocation of the number and the type of the computing resources needed on the compute node to run the AI workload, no output of step 320, then the process proceeds to step 324. If the computer determines that the runtime computing resource reallocation is needed on the compute node based on the time series predictions of the future allocation of the number and the type of the computing resources needed on the compute node to run the AI workload, yes output of step 320, then the computer performs the runtime computing resource reallocation on the compute node automatically to adjust at least one of the number and the type of the computing resources needed on the compute node to run the AI workload (step 322).

The computer makes a determination as to whether the AI workload has completed running on the compute node (step 324). If the computer determines that the AI workload has not completed running on the compute node, no output of step 324, then the process returns to step 314 where the computer continues to run the AI workload on the compute node. If the computer determines that the AI workload has completed running on the compute node, yes output of step 324, then the computer collects completed workload performance data corresponding to the AI workload (step 326).

The computer utilizes the completed workload performance data corresponding to the AI workload as feedback to the regression machine learning model to increase predictive accuracy of the regression machine learning model over time (step 328). Thereafter, the process terminates.

Thus, illustrative embodiments of the present disclosure provide a computer-implemented method, computer system, and computer program product for optimizing computing resource allocation for different AI workloads based on analyzing historical and real-time performance data corresponding to the different AI workloads. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
generating time series predictions of future allocation of number and type of computing resources needed on a compute node to run an Artificial Intelligence (AI) workload based on real-time performance data corresponding to the AI workload running on the compute node;
determining whether runtime computing resource reallocation is needed on the compute node based on the time series predictions of the future allocation of the number and the type of the computing resources needed on the compute node to run the AI workload; and
responsive to determining that the runtime computing resource reallocation is needed on the compute node based on the time series predictions of the future allocation of the number and the type of the computing resources needed on the compute node to run the AI workload, performing the runtime computing resource reallocation on the compute node automatically to adjust at least one of the number and the type of the computing resources needed on the compute node to run the AI workload.

2. The computer-implemented method of claim 1, further comprising:
determining whether the AI workload has completed running on the compute node;
responsive to determining that the AI workload has completed running on the compute node, collecting completed workload performance data corresponding to the AI workload; and
utilizing the completed workload performance data corresponding to the AI workload as feedback to a regression machine learning model to increase predictive accuracy of the regression machine learning model.

3. The computer-implemented method of claim 1, further comprising:
performing static code analysis of the AI workload in response to receiving the AI workload, the static code analysis includes at least one of source code analysis, runtime libraries analysis, system calls analysis, and instructions for binary analysis.

4. The computer-implemented method of claim 1, further comprising:
identifying a type of the AI workload based on static code analysis of the AI workload, the type of the AI workload is one of a data processing AI workload type, a machine learning AI workload type, a deep learning AI workload type, a training AI workload type, an inference AI workload type, and a data analysis AI workload type.

5. The computer-implemented method of claim 1, further comprising:
retrieving historical performance data corresponding to a type of the AI workload; and
predicting the number and the type of the computing resources needed to run the AI workload based on the historical performance data corresponding to the type of the AI workload using a regression machine learning model trained on the historical performance data corresponding to the type of the AI workload.

6. The computer-implemented method of claim 1, further comprising:
selecting the compute node having the number and the type of the computing resources needed to run the AI workload, the compute node is one of a plurality of compute nodes having different computing resources within a heterogeneous computing environment; and
running the AI workload on the compute node having the number and the type of the computing resources needed to run the AI workload.

7. The computer-implemented method of claim 1, further comprising:
collecting the real-time performance data corresponding to the AI workload running on the compute node having the number and the type of the computing resources needed to run the AI workload.

8. A computer system comprising:
a processor set;
one or more computer-readable storage media; and
program instructions stored on the one or more computer-readable storage media to cause the processor set to perform operations comprising:
generating time series predictions of future allocation of number and type of computing resources needed on a compute node to run an Artificial Intelligence (AI) workload based on real-time performance data corresponding to the AI workload running on the compute node;
determining whether runtime computing resource reallocation is needed on the compute node based on the time series predictions of the future allocation of the number and the type of the computing resources needed on the compute node to run the AI workload; and
responsive to determining that the runtime computing resource reallocation is needed on the compute node based on the time series predictions of the future allocation of the number and the type of the computing resources needed on the compute node to run the AI workload, performing the runtime computing resource reallocation on the compute node automatically to adjust at least one of the number and the type of the computing resources needed on the compute node to run the AI workload.

9. The computer system of claim 8, wherein the operations further comprise:
determining whether the AI workload has completed running on the compute node;
responsive to determining that the AI workload has completed running on the compute node, collecting completed workload performance data corresponding to the AI workload; and
utilizing the completed workload performance data corresponding to the AI workload as feedback to a regression machine learning model to increase predictive accuracy of the regression machine learning model.

10. The computer system of claim 8, wherein the operations further comprise:
performing static code analysis of the AI workload in response to receiving the AI workload, the static code analysis includes at least one of source code analysis, runtime libraries analysis, system calls analysis, and instructions for binary analysis.

11. The computer system of claim 8, wherein the operations further comprise:
identifying a type of the AI workload based on static code analysis of the AI workload, the type of the AI workload is one of a data processing AI workload type, a machine learning AI workload type, a deep learning AI workload type, a training AI workload type, an inference AI workload type, and a data analysis AI workload type.

12. The computer system of claim 8, wherein the operations further comprise:
retrieving historical performance data corresponding to a type of the AI workload; and
predicting the number and the type of the computing resources needed to run the AI workload based on the historical performance data corresponding to the type of the AI workload using a regression machine learning model trained on the historical performance data corresponding to the type of the AI workload.

13. The computer system of claim 8, wherein the operations further comprise:
selecting the compute node having the number and the type of the computing resources needed to run the AI workload, the compute node is one of a plurality of compute nodes having different computing resources within a heterogeneous computing environment; and
running the AI workload on the compute node having the number and the type of the computing resources needed to run the AI workload.

14. A computer program product comprising:
one or more computer-readable storage media; and
program instructions stored on the one or more computer-readable storage media to perform operations comprising:
generating time series predictions of future allocation of number and type of computing resources needed on a compute node to run an Artificial Intelligence (AI) workload based on real-time performance data corresponding to the AI workload running on the compute node;
determining whether runtime computing resource reallocation is needed on the compute node based on the time series predictions of the future allocation of the number and the type of the computing resources needed on the compute node to run the AI workload; and
responsive to determining that the runtime computing resource reallocation is needed on the compute node based on the time series predictions of the future allocation of the number and the type of the computing resources needed on the compute node to run the AI workload, performing the runtime computing resource reallocation on the compute node automatically to adjust at least one of the number and the type of the computing resources needed on the compute node to run the AI workload.

15. The computer program product of claim 14, wherein the operations further comprise:
determining whether the AI workload has completed running on the compute node;
responsive to determining that the AI workload has completed running on the compute node, collecting completed workload performance data corresponding to the AI workload; and
utilizing the completed workload performance data corresponding to the AI workload as feedback to a regression machine learning model to increase predictive accuracy of the regression machine learning model.

16. The computer program product of claim 14, wherein the operations further comprise:
performing static code analysis of the AI workload in response to receiving the AI workload, the static code analysis includes at least one of source code analysis, runtime libraries analysis, system calls analysis, and instructions for binary analysis.

17. The computer program product of claim 14, wherein the operations further comprise:
identifying a type of the AI workload based on static code analysis of the AI workload, the type of the AI workload is one of a data processing AI workload type, a machine learning AI workload type, a deep learning AI workload type, a training AI workload type, an inference AI workload type, and a data analysis AI workload type.

18. The computer program product of claim 14, wherein the operations further comprise:
retrieving historical performance data corresponding to a type of the AI workload; and
predicting the number and the type of the computing resources needed to run the AI workload based on the historical performance data corresponding to the type of the AI workload using a regression machine learning model trained on the historical performance data corresponding to the type of the AI workload.

19. The computer program product of claim 14, wherein the operations further comprise:
selecting the compute node having the number and the type of the computing resources needed to run the AI workload, the compute node is one of a plurality of compute nodes having different computing resources within a heterogeneous computing environment; and
running the AI workload on the compute node having the number and the type of the computing resources needed to run the AI workload.

20. The computer program product of claim 14, wherein the operations further comprise:
collecting the real-time performance data corresponding to the AI workload running on the compute node having the number and the type of the computing resources needed to run the AI workload.
